(19) United States
(12) Patent Application Publication
(10) Pub. No.: US 2002/0094261 A1
(43) Pub. Date: Jul. 18, 2002

(54) Motor vehicle with loading ramp

(76) Inventors: Ute Fischer, Koenigsbach-Stein (DE); Mathias Lenz, Stuttgart (DE)

Correspondence Address: KENYON & KENYON, ONE BROADWAY, NEW YORK, NY, 10004, US

(21) Appl. No.: 10/026,986

(22) Filed: Dec. 18, 2001

(30) Foreign Application Priority Data
Dec. 20, 2000 (DE) 100 63 652.7

(51) Int. Cl. B60R 3/00; B62D 31/00; B65F 1/00

(52) U.S. Cl. 414/537; 280/166; 296/26.09

(57) ABSTRACT

A motor vehicle, particularly a passenger car, includes a storage compartment, closable by at least one gate, which is delimited on its bottom by an essentially horizontal bottom plate fixed to the vehicle. At least one loading ramp is located in the storage compartment below the bottom plate which is mounted in a horizontal guide and is adjustable when the gate is open between an inserted position, in which the loading ramp is completely accommodated in the storage compartment, and an extended position, in which the loading ramp extends from the vehicle and rests on a ground on which the vehicle stands. An end section of the loading ramp facing the storage compartment is pivotable around a pivot axis which extends transverse to the lengthwise axis of the loading ramp. This pivot axis is positioned in this case so that in the extended position an end edge of the ramp facing the bottom plate sits approximately flush with an end edge of the bottom plate facing the loading ramp.

### FIELD OF THE INVENTION

The present invention relates to a motor vehicle, particularly a passenger vehicle, having a storage compartment which may be closed by at least one gate and having at least one loading ramp which is to simplify the loading and unloading of the storage compartment.

### BACKGROUND INFORMATION

U.S. Pat. No. 5,813,714 describes a vehicle having a driver's cab and a loading bay positioned behind it which is open at the top. The loading bay is delimited to the rear by a tailgate and to the bottom by an essentially horizontal bottom plate fixed to the vehicle. The tailgate is pivotable around a vehicle transverse axis and can be swung open into a horizontal position to open the loading bay. A plate-shaped loading ramp can be hung on the horizontally opened tailgate in order to carry, push, or roll an object onto the loading bay via the loading ramp in this way.

British Published Patent Application No. 2 276 592 describes a vehicle in the rear of which a storage compartment is implemented. Two recesses, separated from one another by approximately the track width of a wheelchair, are left open in a floor plate, which is fixed to the vehicle and delimits the bottom of the storage compartment. Telescopic loading ramps, which are implemented in the form of rails having a U-shaped cross-section open at the top, are provided for loading a wheelchair into the storage compartment or unloading it from the storage compartment. For loading and unloading of the wheelchair, the loading ramps are hooked onto the rear of the vehicle, with the rear being equipped for this purpose with a bumper which can be folded down at least in this section.

A passenger vehicle is described in International Published Patent Application No. WO 82/02175 in the rear of which a storage compartment is implemented. A storage compartment floor which delimits the storage compartment at the bottom can be extended horizontally out of the vehicle to the rear when the tailgate is open and thus simplifies the loading and unloading of the storage compartment. However, a ramp function cannot be assigned to this extendable bottom plate.

In conventional vehicles, there is the disadvantage that the loading ramp must additionally be stored in the storage compartment when it is not needed and thus occupies the storage compartment which, accordingly, is not available for a payload.

It is an object of the present invention to provide a vehicle of the type described above which allows space-saving accommodation of the loading ramp when it is not needed.

### SUMMARY

The above and other beneficial objects of the present invention are achieved by providing a vehicle as described herein.

The present invention is based on the concept of accommodating the loading ramp inside the vehicle, below the bottom plate fixed to the vehicle, with a corresponding horizontal guide being provided that allows retraction and extension of the loading ramp between a retracted position and an extended position. With these measures, the loading ramp vanishes below the bottom plate in the storage compartment when it is not needed and thus does not occupy any storage space in the storage compartment, which may thus be used without restriction. Furthermore, it is ensured by these measures that the loading ramp may be moved between its retracted position and its extended position independently of the loading state of the storage compartment and is thus always available.

In order to further simplify loading and unloading via the ramp, according to the present invention, the pivot axis around which the extended loading ramp pivots relative to the vehicle is positioned so that in the extended position an end edge of the ramp facing the bottom plate sits approximately flush with an end edge of the bottom plate facing the loading ramp. In this manner, an essentially obstruction-free transition between the bottom plate and the ramp results, which simplifies loading and unloading. The loading ramp may be attached so that the loading ramp is clamped onto the vehicle so that it may not be lost.

In an example embodiment of the present invention, a bearing slide, on which the end section of the loading ramp facing the storage compartment is pivotable around the pivot axis, may be guided and mounted so that it is horizontally adjustable in the horizontal guide located below the bottom plate, with a section of the bearing slide facing away from the loading ramp still being within the horizontal guide when the loading ramp is in the extended position. With these measures, a stable support for the extended loading ramp results, as well as a secure positioning for the pivot mounting of the loading ramp, with this pivot mounting being horizontally adjustable with the bearing slide.

In order to obtain the least possible incline for the extended ramp, the loading ramp may be implemented as telescopic and may include at least two ramp elements which are able to be adjusted relative to one another and are mounted end to end in the lengthwise direction of the ramp. At the same time, the implementation of a telescopic ramp allows a minimal space requirement in the inserted state.

In an example embodiment, in which the ramp at the rear of the vehicle may be extended to the rear out of the storage compartment in the lengthwise direction of the vehicle, a bumper of the vehicle may be implemented as slanted on its upper side so that a large area of the extended loading ramp is on the upper side of the bumper. With these features, the bumper may effectively support the loading ramp in its extended position, reducing the danger of damage to the loading ramp and/or the bumper. In addition, the load on the pivot mounting during a loading and/or unloading procedure is thus reduced.

Further important features and advantages of the present invention result from the Figures and from the associated description of the Figures with reference thereto.

The features described above and below may be used not only in the respective combination indicated, but also in other combinations or alone without departing from the scope of the present invention.

An example embodiment of the present invention is illustrated in the Figures and is explained in more detail in the following description.

### DETAILED DESCRIPTION

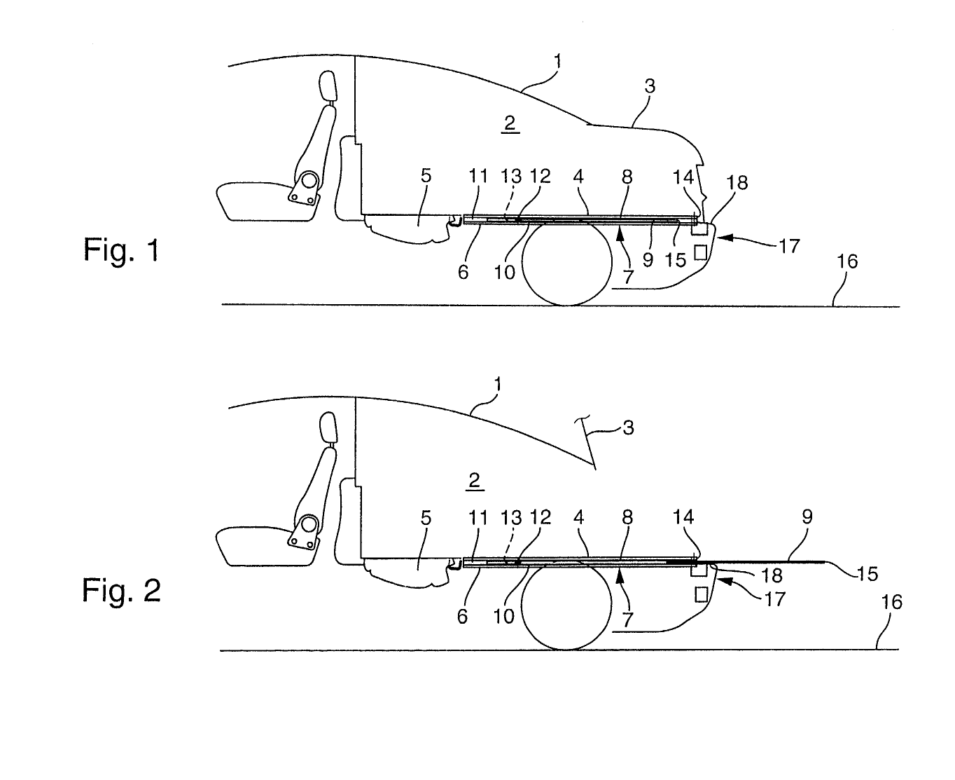

FIGS. 1 to 4 schematically illustrate a sequence of side views of a motor vehicle according to the present invention during the movement of a loading ramp between its inserted position and its extended position.

### DETAILED DESCRIPTION

As illustrated in FIGS. 1 to 4, a vehicle 1 according to the present invention may, for example, be implemented as a passenger car. In addition to the notchback implementation illustrated, the passenger vehicle may also have a fastback or a station wagon implementation. A storage compartment 2 is implemented in the rear of vehicle 1 which may be closed using a tailgate 3. In the example embodiment illustrated, when tailgate 3 is closed, storage compartment 2 is completely integrated in the outer contour of vehicle 1 and is thus completely closed. The implementation of the present invention is, however, also possible in motor vehicles in which storage compartment 2 is positioned in a loading bay which is open at the top. This type of vehicle is enjoying increasing popularity and is generally referred to as a “pickup.” Storage compartment 2 is delimited on its bottom by a bottom plate 4 which extends essentially horizontally. In the example embodiment illustrated, next to this bottom plate 4, at its front end in the direction of travel, there is a rear seat 5, which is folded down in this case to enlarge storage compartment 2.

A horizontal guide 6 is positioned below bottom plate 4 which includes, for example, two guiderails extending parallel to the lengthwise direction of the vehicle. These rails both are in a horizontal plane and have C-shaped cross-sections, with the open lengthwise side of one guide rail being opposite the open lengthwise side of the other guiderail.

A telescopic loading ramp 7 is mounted in this horizontal guide 6 so it is horizontally adjustable. For example, side edges of loading ramp 7 engage in the open lengthwise sides of the guiderails. This loading ramp 7 is, for example, implemented as plate-shaped and may extend over the entire width of bottom plate 4 and/or the rear opening of storage compartment 2 in the transverse direction of the vehicle. An example embodiment with two or more loading ramps is also possible, which may, for example, implement a ramp for a wheelchair or similar vehicle having a predetermined track width.

Telescopic loading ramp 7 has, in the embodiment illustrated, an outer ramp element 8 and an inner ramp element 9, which are adjustably mounted end to end in the lengthwise direction of loading ramp 7. Outer ramp element 8 may have a cross-section with an outer contour or envelope, completely closed transverse to the lengthwise direction of the ramp, which completely surrounds and encloses inner ramp element 9 inserted therein transverse to the lengthwise direction of the ramp.

Loading ramp 7 and/or, in this case, external ramp element 8 is mounted at an end section 10 at the front in the direction of travel on a bearing slide 11, which is also adjustably guided in horizontal guide 6. Loading ramp 7 is mounted on this bearing slide 11 so it may be adjusted by pivoting around a pivot axis 12 which extends transverse to the extension direction and/or transverse to the lengthwise direction of ramp 7. In the example embodiment, this pivot axis 12 thus extends transverse to the lengthwise direction of the vehicle and is perpendicular to the plane of the Figure. The positioning of this pivot axis 12 is selected according to the present invention so that an end edge 13 of the ramp facing bottom plate 4 sits approximately flush with an end edge 14 of the bottom plate facing loading ramp 7, so that the transition between loading ramp 7 and bottom plate 4 results without an interrupting contour, particularly without a shoulder.

The present invention operates as follows:

As illustrated in FIG. 1, loading ramp 7 is in an inserted position in which tailgate 3 of motor vehicle 1 may be closed. Loading ramp 7 is below bottom plate 4, which in this case forms the floor of the storage compartment, and thus does not impair storage compartment 2 in any manner.

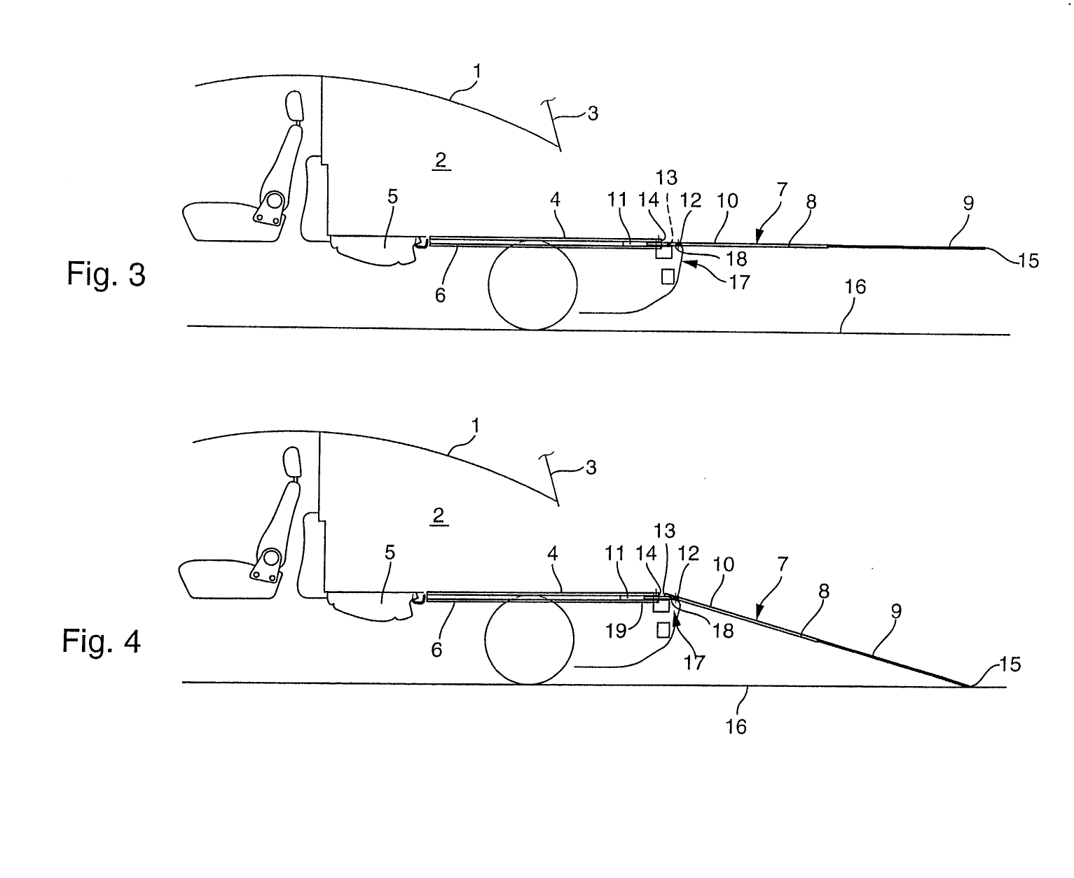

When tailgate 3 is open, as illustrated in FIG. 2, loading ramp 7 may be extended horizontally to the rear from the rear of vehicle 1. In this case, inner ramp element 9 may first be extended out of outer ramp element 8 as illustrated in FIG. 2. As soon as inner ramp element 9 has reached its final position, outer ramp element 8 may also be extended as illustrated in FIG. 3.

If, as illustrated in FIG. 4, outer ramp element 8 has thus reached its maximum extended position, extended loading ramp 7 and/or its outer ramp element 8 may be pivoted downward around pivot axis 12 until end 15 of loading ramp 7 and/or inner ramp element 9 facing away from vehicle 1 is on floor or ground 16, on which vehicle 1 also stands. Loading ramp 7 then assumes its extended position as illustrated in FIG. 4. The respective final positions of the extension movements may be defined by stops.

As illustrated in FIG. 4, a section 19 of bearing slide 11 facing away from loading ramp 7 remains within the horizontal guide when loading ramp 7 is completely extended out of horizontal guide 6. With this construction, secure support of loading ramp 7 on the rear of vehicle 1 via bearing slide 11 and horizontal guide 6 results, even when loading ramp 7 is extended.

It may be particularly important in this case that the adjustment of loading ramp 7 between its inserted position illustrated in FIG. 1 and its extended position illustrated in FIG. 4 may occur independently of the loading state of bottom plate 4.

In the example embodiment illustrated, a bumper 17 implemented on the rear of vehicle 1 is implemented as slanted on its upper side 18 so that a large area of the bottom of loading ramp 7 and/or its outer ramp element 8 comes to rest on slanted upper side 18 of bumper 17 as soon as loading ramp 7 assumes its extended position illustrated in FIG. 4. Bumper 17 accordingly provides a large-area, and thus effective, support of loading ramp 7.

In another example embodiment, the shape of bumper 17 may also be implemented so that no contact may occur between loading ramp 7 and bumper 17 even in the extended position illustrated in FIG. 4.

What is claimed is:

1. A motor vehicle, comprising:
a storage compartment closable by at least one gate, the storage compartment delimited on a bottom by a substantially horizontal bottom plate fixed to the vehicle;
a horizontal guide; and
at least one loading ramp arranged below the bottom plate in the storage compartment and mounted in the horizontal guide, when the gate is open, the loading ramp adjustable between an inserted position in which the loading ramp is completely accommodated in the storage compartment and an extended position in which the loading ramp protrudes from the vehicle and is on a ground on which the vehicle stands, an end section of the loading ramp facing the storage compartment pivotable around a pivot axis extending transversely to a lengthwise axis of the loading ramp, the pivot axis positioned on the loading ramp so that in the extended position, an edge of the loading ramp facing the bottom plate is approximately flush with an end edge of the bottom plate facing the loading ramp.

2. The vehicle according to claim 1, wherein the motor vehicle includes a passenger car.

3. The vehicle according to claim 1, further comprising a bearing slide horizontally adjustably mounted in the horizontal guide, the end section of the loading ramp facing the storage compartment pivotable on the bearing slide around the pivot axis, a section of the bearing slide facing away from the loading ramp arranged within the horizontal guide in the extended position of the loading ramp.

4. The vehicle according to claim 1, wherein the loading ramp is telescopic and includes at least two ramp elements adjustable relative to one another in a lengthwise direction of the ramp and are mounted end to end.

5. The vehicle according to claim 1, wherein the loading ramp is extendable laterally from the storage compartment transversely to a lengthwise direction of the vehicle.

6. The vehicle according to claim 1, wherein the loading ramp is arranged at a rear of the vehicle and extendable to the rear from the storage compartment in a lengthwise direction of the vehicle.

7. The vehicle according to claim 6, further comprising a bumper arranged at the rear of the vehicle and configured to support the extended loading ramp from below with its top.

8. The vehicle according to claim 7, wherein the bumper is slanted on an upper side so that a large area of the extended loading ramp rests on the top of the bumper.

9. The vehicle according to claim 1, wherein the loading ramp is plate-shaped and extends transversely to its lengthwise direction approximately over an entire width of the bottom plate of the storage compartment.

10. The vehicle according to claim 1, wherein the loading ramp includes an outer ramp element supported in the horizontal guide and an inner ramp element adjustably supported in the outer ramp element, the outer ramp element having a cross-section closed in a direction transverse to a lengthwise axis of the loading ramp and enclosing the inner ramp inserted therein.
